(19) United States
(12) Patent Application Publication
(10) Pub. No.: US 2006/0124326 A1
(43) Pub. Date: Jun. 15, 2006

(54) Rotary weed removal device

(76) Inventor: Bob G. Gilley, Tyler, TX (US)

Correspondence Address: Ronald B. Sefrna;Sefrna & Associates, P.O. Box 567, Tyler, TX, 75710-0567, US

(21) Appl. No.: 10/999,285

(22) Filed: Nov. 30, 2004

(51) Int. Cl. A01B 1/00

(52) U.S. Cl. 172/378

(57) ABSTRACT

A rotating weed removal device includes an elongate rod with a plurality of tines extending through and loosely retained in a plurality of apertures disposed at the lower end of the rod in spaced apart relation, such that each of the tines is free to rotate within the aperture through which the tine extends, but is retained in the aperture by bends in the outer ends of each tine. In use, the upper end of the rod is connected to a rotary drive means, such as a cordless drill motor, the lower end of the rod is placed on the soil adjacent to a weed to be removed, the drive means is activated, and downward pressure is applied to cause the rotating rod to penetrate the soil and the revolving tines to engage and loosen the roots of the weed by winding the roots into the tines, allowing the weed to be easily lifted from the soil with roots substantially intact.

### FIELD OF THE INVENTION

The present invention generally relates to the field of gardening and agricultural tools and implements, and in its preferred embodiments more specifically relates to a device for engaging, loosening, and removing weeds from lawns, gardens, and the like.

### BACKGROUND OF THE INVENTION

Undesirable or unwanted plants have always been a problem for gardeners, and the chore or removing these plants, or weeds, is as old as the practice of gardening itself. Typically, weeds are native to the area in which the gardener is working, and are very hardy and fast growing. Many of these plants develop deep and extensive root systems very quickly, which makes the plants difficult to remove from the soil. In many instances, if any portion of the root remains in the soil the plant will grow again from the root and eventually reappear above the ground. It is, therefore, desirable to remove not only the exposed portion of the weed, but as much of the root as possible. It is also desirable to remove weeds from the soil with as little disturbance or damage to adjacent desirable plants as possible.

Pulling weeds by hand is probably the earliest approach used to remove weeds and other undesirable plants, and can be reasonably effective if the weeds have not developed extensive root systems. Hand weeding is, however, very tedious and tiring work. Implements such as spades and hoes have also been widely used for removing weeds, but this approach is more suited to broad scale weed removal in agricultural fields than to lawns and ornamental gardens, where use of these implements is much more likely to damage desirable plants. Large scale mechanized apparatus has been developed for controlling weeds in agricultural applications, but this approach is also unsuitable for lawns, ornamental gardens, or small vegetable gardens.

A number of implements and devices have been designed for use in removing individual weeds lawns and gardens, including both manually operated devices and powered devices, but all such devices known in the prior art suffer from various disadvantages. Manually operated devices known in the prior art include spades or trowels with narrow blades, for digging out weeds and minimizing disturbance to surrounding soil and plants. Although the various spade-like devices are a improvement over hand pulling, they often cut the root(s) the plant, leaving much of the root in the ground, and their use remains very tedious and tiring.

Other devices are designed for use by a person from a standing position, and are characterized by an elongate handle with some form of weed-engaging shape at the lower end. In one design, several prongs extend outwardly from and parallel to the lower end of the handle, to be inserted into the ground around the weed and then rotated, by turning the handle. The intention is to entangle the weed roots in the prongs so that the weed plant can be lifted from the ground. Although this device can be effective with some types of weeds, it does not work well with weeds that have a long main root or tap root. In a variation of this design, a laterally extending hook is rigidly attached to one or more of the heavy longitudinal prongs or cutters, for the purpose of engaging the tap root and winding it in the device so it can be pulled from the ground. This design is more effective in engaging the roots of the weed, but it can be difficult to remove the weed from the device after it is pulled from the ground because the roots become entangled in the rigid prongs and hook(s). This device can be turned by hand, using a crossbar at the top of the handle, or it could be turned using a motor.

Another weed pulling device, intended to be used with a motor such as an electric drill motor, utilizes a spiral blade at the bottom end of an elongate driver rod, which is attached at its upper end to the motor. When the motor is activated the spiral blade screws into the ground into or next to the weed, and is intended to engage the weed root in the spiral. This design, however, often does not wrap the root into the spiral blade, but cuts the root just below the surface.

### SUMMARY OF THE INVENTION

The present invention provides a weed removal device of a novel design, distinct from anything known in the prior art, that will quickly and effectively burrow into the ground next to a weed plant, engage the roots of a weed without breaking or cutting them, and allow the weed to be easily pulled from the ground with the roots substantially intact. The design of the device of the invention allows the removed weed to be easily and quickly disengaged from the device without the necessity of manually unwinding the weed roots from the device.

The device of the invention includes an elongate rod with an upper end and a lower end, preferably configured and sized so that the upper end of the rod can be received and secured in the chuck of a conventional, preferably cordless, hand drill. The lower end of the rod is preferably formed with a chisel point or pointed tip to facilitate initial entry into the ground beside a weed to be removed from the ground with the device. The rod is penetrated by a plurality of tine apertures near the lower end of the rod, with the apertures longitudinally spaced through the lower portion of the rod adjacent to the lower end. A tine is loosely disposed in each aperture, and the outer portion of each of the tines is bent at an angle relative to the central portion of the tine that extends through the aperture. The relationship between the size of the aperture, the thickness of the tine, and the angle of the bends in the tine is such that the tines are retained in the aperture in engagement with the rod by the bends, but are allowed to rotate in the aperture, and move within the aperture between the constraining bends. It is preferred that the length of extension of each tine outwardly from the rod increases from the tine nearest the lower end of the rod through the tines progressively farther from the lower end of the rod, but this length relationship is not critical within the scope of the invention.

The device of the invention is used by connecting the upper end of the rod a rotary drive means, such as a cordless variable speed drill motor, to cause rotation of the rod and attached tines around the longitudinal axis of the rod. The lower end of the rod is placed on the surface of the soil directly beside the crown or stem of a weed to be removed, with the rod extending vertically upward from the soil, and the drive means is activated to cause the rod to rotate. The point at the lower end of the rod opens a passageway into the soil for the rod, and the lower tines of the device expand that passageway and begin loosening the soil around the weed. As the device penetrates deeper into the soil the rotating tines sweep against the roots of the weed and entangle the roots of the weed in and between the tines. The configuration of the tines helps to move a tap root inward toward the rod, and the rotation of the device causes the tap root to rotate generally around its axis and loosen from the soil along its length. Because the tines of the device do not have sharp edges they do not cut the roots, but loosen and rotate them to facilitate removal of the major portion of the root system. When the weed is loosened and freely rotating, the device and weed may be easily lifted from the soil by lifting the drive means. Unlike many of the weed removal devices of the prior art, the device of the invention is designed to readily release weeds, almost completely eliminating any need to manually remove a weed before the device can be used again. Because the tines are not firmly attached and are able to move relative to the rod, tapping the end of the rod against the ground or tapping the side of the rod or the tines against the side of the user's foot will cause the tines to shift and release the weed and roots.

The structure and features of preferred and alternative embodiments of the device will be described in detail with reference to the accompanying drawing figures.

### BRIEF DESCRIPTION OF THE DRAWINGS

FIG. 1 is a side elevation view of a preferred embodiment of the device of the invention.

FIG. 2 is a side elevation view of a portion of the bottom end of a preferred embodiment of the device of the invention, showing one of the upper tines in greater detail.

FIG. 3 is a side elevation view of a lower portion of the bottom end of a preferred embodiment of the device of the invention, showing the lowest tine.

FIG. 4 is a top view of a preferred embodiment of the device of the invention, illustrating one tine orientation.

FIG. 5 is a top view of a single tine of a preferred embodiment of the device of the invention.

FIG. 6 is a top view of a single tine of an alternative embodiment of the device of the invention.

FIG. 7 is a side elevation view of an alternative embodiment of the device of the invention, in which the alternative tine embodiment of FIG. 6 is used.

FIG. 8 is a top view of the alternative embodiment shown in FIG. 7.

FIG. 9 is a side elevation view of a further alternative embodiment of the device of the invention, illustrating a non-symmetrical tine placement.

FIG. 10 is a top view of another alternative embodiment of the device of the invention, illustrating an alternative aperture orientation.

### DETAILED DESCRIPTION OF THE INVENTION

Referring to the drawing figures, the device of the invention, generally designated by reference numeral 10, comprises an elongate rod 11 with a first, or upper end 12 and a second, or lower end 13. It is preferred that a chisel point or notch 14 be formed at the lower end 13 of the rod, to facilitate breaking the surface of the soil and the penetration of the rod into the soil as the device is used. Point 14 functions primarily to push soil laterally away from the rod and assist in opening a pathway for the rod to follow in the soil, and accordingly it is not necessary that the lower end of the rod be formed with a spiral or threaded pattern to draw the rod into the soil, although such a configuration could b e used if desired.

In the preferred embodiment, rod 11 is constructed of steel, and has a diameter of approximately one fourth to three eights inch, so that the upper end 12 can be received and secured in the chuck of a conventional, preferably cordless, drill motor. Rods of small diameter may not be sufficiently rigid to be pressed into the soil without bowing, or to withstand the torsional stress of rotation, and rods of large diameter would be difficult to force into the soil and unnecessarily heavy. Although the device of the invention is designed to be effectively driven by an electric drill motor, the motor itself is not within the scope of the invention, and the invention is not limited to the use of any particular driving means. Any drive means may be used, as long as it is capable of rotating the device at a sufficient rate to achieve the intended action and functions of the device. It will also be understood that neither the material of construction nor the specific diameter or cross-sectional configuration of the of the components of the device are critical to the invention, and any material, of any configuration and dimension, that enables the device to perform the intended actions and functions may be used within the scope of the invention.

A plurality of tines 15 are disposed at the lower end 13 of rod 11, to engage and capture the weed roots as the device is used. It is preferred that three or four tines be used and in a particularly preferred embodiment four tines are utilized, but both smaller and larger numbers of tines can be used. Two tines may be satisfactory for a light duty device to be used to remove weeds with relatively smaller root systems. Similarly, a larger number of tines may be used in a heavy duty device for removing larger weeds, and the dimensions of the components increased as appropriate to the higher stresses and levels of force involved.

Each of tines 15 is connected to rod 11 by extending the tine through a tine aperture 16 penetrating rod 11 with the axis of the aperture generally perpendicular to the longitudinal axis of rod 11. The tines are retained in their respective apertures by bends 17 in the tine on either side of the portion of the tine received in the aperture. The diameter of the tines is less than the diameter of the respective apertures so that the tines fit loosely enough in the apertures to rotate relative to the rod, but tightly enough that the bent portions of the tines will not pass through the apertures and allow the tines to separate from the rod.

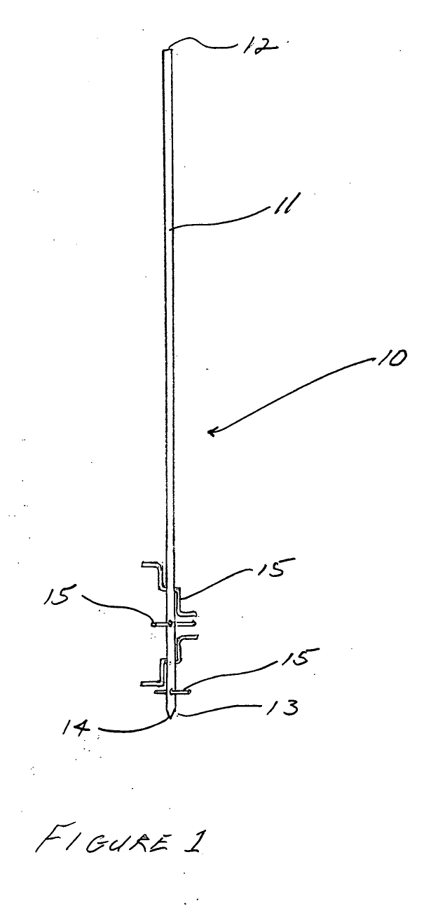

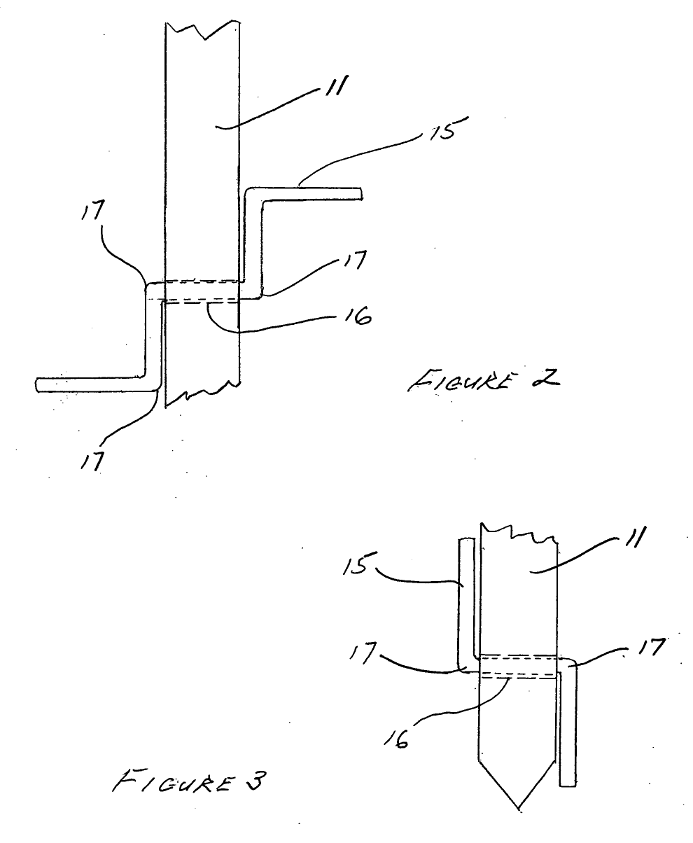

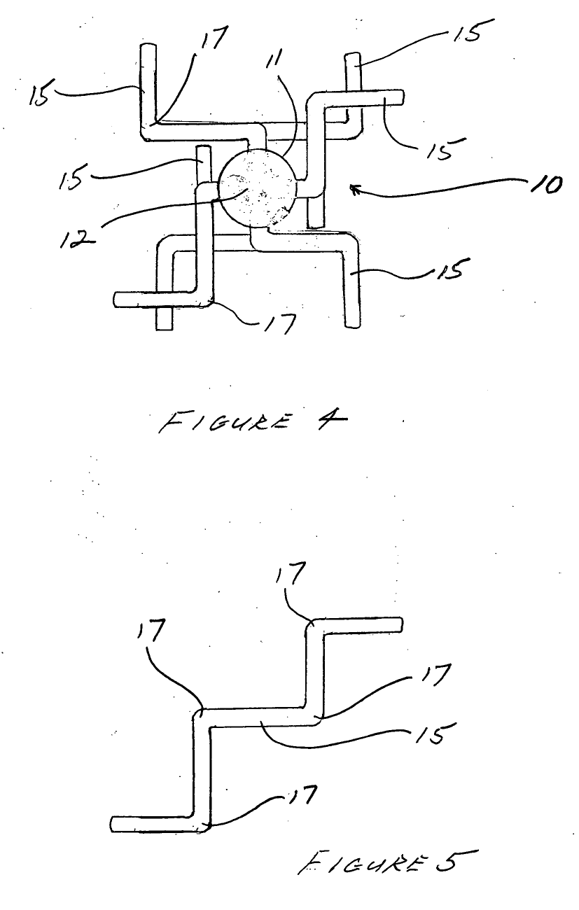

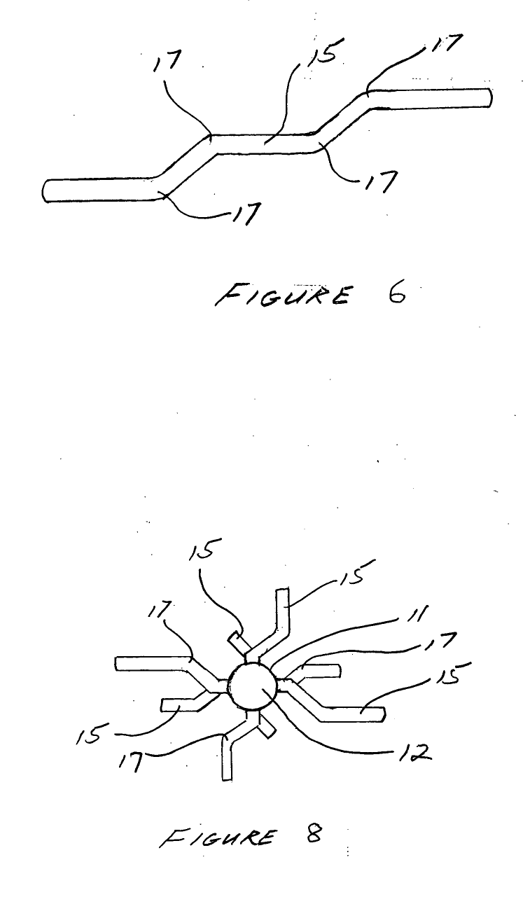

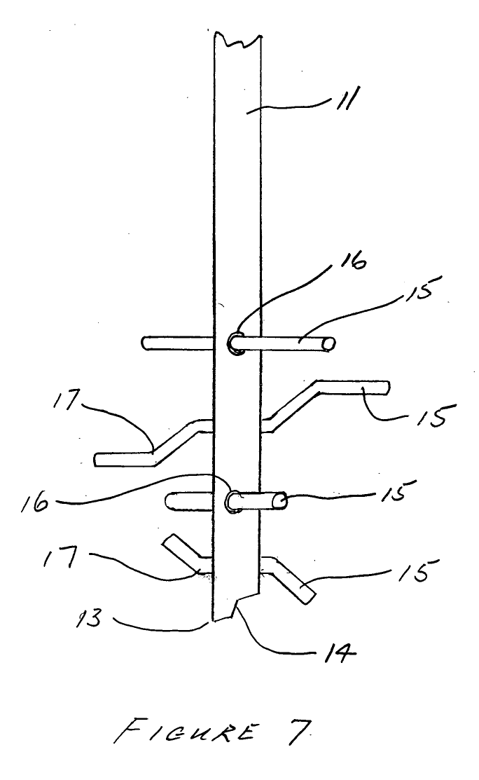

In the preferred embodiment of FIGS. 1 through 5, each outwardly extending portion of each tine is bent at an angle of approximately ninety degrees relative to the axis of the central portion of the tine within the tine aperture. The bends in the portions of the tine on opposite sides of the rod are made in opposite directions. No further bends are made in the shortest tine of the primary embodiment, but a second bend of approximately ninety degrees is made in each portion of the remaining, longer, tines, to bring the end portions of each tine back into parallel relation to each other and to the central portion extending through the aperture. The bending of these tines relative to the rod is illustrated in FIGS. 2 and 3, and in FIG. 5, which provides an isolated view of a single tine. Although the bending of the tines as disclosed above is preferred, the number and angle of the bends in the outwardly extending portion(s) of the tines can be varied within the scope of the invention. FIGS. 6 through 8 illustrate an alternative embodiment in which the tines are bent to angles of approximately forty-five degrees rather than the ninety degree bends of the preferred embodiment. It is preferred that the angle between adjacent portions of each tine be no more than ninety degrees, so that no portion of a tine turns back toward the rod. The number of bends may vary from tine to tine, though it is generally preferred that longer tines have more bends than shorter tines.

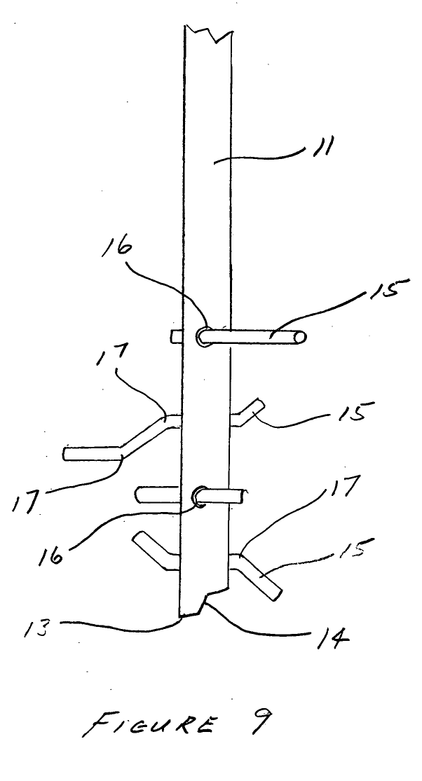

The distance of extension of the tines outwardly from rod 11 is preferably shortest for the lowest tine, closest to the lower end 13 of rod 11. In the preferred embodiment the length, or distance of extension, of all the upper tines is greater than the length of the lowest tines, and is approximately equal. However, although it is preferred that the lowest tine be the shortest, to facilitate entry of the device into the soil, the length relationship among the upper tines is not critical within the scope of the invention, and tines of unequal length may be used. In the alternative embodiment shown in FIGS. 7 and 8, the length of the tines increases as the distance of the tines from the lower end of the rod increases. In this alternative embodiment the volume “swept” by the tines as rod 11 is rotated is generally conical in configuration.

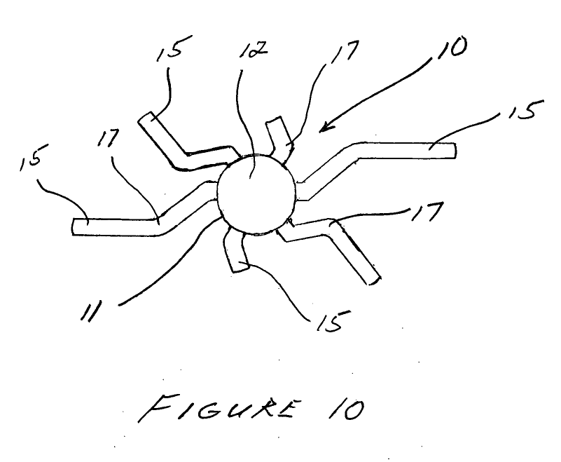

In the preferred embodiment of the device the tines 15 are generally symmetrically disposed in their respective aperture 16, with the central portion of the tine in the aperture and the distance of extension of the opposing ends of the tine outward from the aperture generally equal. However, alternative embodiments in which some or all of the tines are asymmetrically disposed are encompassed within the scope of the invention. Such an alternative embodiment, in which the second and third tines are asymmetrically disposed, is illustrated in FIGS. 9 and 10. Any tine positioning arrangement may be used, so long as a sufficient portion of the tine extends from the aperture to allow the tine to be restrained against passage back through the aperture.

The axes of apertures 16 are preferably generally perpendicular to the longitudinal axis of rod 11, although the invention also encompasses arrangements in which the axis of one or more of the apertures is offset from perpendicular to the axis of the rod. It is further preferred that the axes of apertures 16 be radially offset from each other around the axis of rod 11, so that the tines extend outwardly from the rod in at least slightly different directions. In the preferred embodiment each successive aperture is offset by approximately ninety degrees from the adjacent apertures however, he scope of the invention also includes angular arrangements in which the apertures are radially aligned and all tines extend from the rod 11 the same direction, as well as arrangements in which the angle of offset between adjacent tines is other than ninety degrees. In the alternative embodiment shown in FIG. 10, an alternative angle of offset is used. The spacing between the apertures 16 is preferably generally symmetrical, although, as with the other special relationships discussed, asymmetrical spacing is within the scope of the invention. In general, it is preferred that as the tines of the device are rotated within their respective apertures, a portion of adjacent tines will come into contact during the rotation, but will not entangle each other so as to prevent further rotation. Bend angles, longitudinal spacing, and axial relationship play an interactive role in achieving the preferred tine interaction, and a wide range of variation in those parameters is possible within the scope of the invention.

The device of the invention is used by securely connecting upper end 12 of rod 11 to a rotary drive means, that will operate to rotate the rod and attached tines around the longitudinal axis of the rod. A cordless, variable speed electric drill motor is very well suited for use with the device of the invention, but, as noted above, any drive means that provides the necessary rotation with sufficient torque to operate the device may be used. The lower end 13 of the device is placed on the surface of the soil directly beside the crown or stem of a weed to be removed, with the rod extending vertically upward from the soil, and the drive means is activated to cause the rod to rotate. Downward force is imposed along the axis of rod 11 while the rod is rotating to push the rod into the soil. Point 14 opens a passageway into the soil for the rod, and the lower tines of the device expand that passageway and begin loosening the soil around the weed. As the device penetrates deeper into the soil the rotating tines sweep against the roots of the weed and entangle the roots of the weed in and between the tines. The configuration of the tines helps to move a tap root inward toward the rod, and the rotation of the device causes the tap root to rotate generally around its axis and loosen from the soil along its length. Because the tines of the device do not have sharp edges they do not cut the roots, but loosen and rotate them to facilitate removal of the major portion of the root system. When the weed is loosened and freely rotating, the device and weed may be easily withdrawn from the soil by lifting the drive means. Unlike many of the weed removal devices of the prior art, the device of the invention is designed to readily release weeds, almost completely eliminating any need to manually remove a weed before the device can be used again. Because the tines are not firmly attached and are able to move relative to the rod, tapping the end of the rod against the ground or tapping the side of the rod or the tines against the side of the user's foot will cause the tines to shift and release the weed and roots, which fall easily away from the tines. The drive means may be briefly activated to assist in fully dislodging the loosened roots.

Plant roots are fibrous structures, with the fibers extending longitudinally along the length of the root. Unless the root fibers are cut, they typically have sufficient tensile strength to resist breaking and allow essentially all of the length of a root to be pulled from well loosened soil. The device of the invention avoids cutting of root fibers and thoroughly loosens the soil around the roots, thereby creating an optimal situation for removal of a weed's complete root structure with minimal disturbance of surrounding soil and adjacent plants.

The foregoing description of the structure and function of the device of the invention and the description of primary and alternative embodiments is intended to be illustrative and not for purposes of limitation. The device of the invention is subject to further variation and a variety of additional alternative embodiments within the scope of the invention, as it will be understood from the foregoing description.

1. A weed removal device comprising
an elongate rod having a first end, a second end, and a longitudinal axis, said rod being rotatable around said longitudinal axis, said rod being penetrated by a plurality of apertures, each having an axis, said apertures extending through said rod with said axes of said apertures generally perpendicular to said longitudinal axis of said rod, with said apertures disposed adjacent to said second end of said rod; and
a plurality of tines, equal in number to the number of said apertures, each of said tines having a first outer portion, a second outer portion, and an intermediate portion between said first and second outer portions, each of said tines extending through a respective one of said apertures with said first and second outer portions of each of said tines extending outwardly from said rod in generally opposed relation to each other, and with said intermediate portion of each of said tines disposed in said aperture, said first and second outer portions of each of said tines extending from said intermediate portion of said tine at an angle of not greater than ninety degrees, so as to prevent removal of said tines from said apertures.

2. The weed removal device of claim 1, wherein said first and second outer portions of each of said tines extend from said intermediate portion of said tine in opposite directions.

3. The weed removal device of claim 1, wherein the cross-sectional dimension of each of said apertures is greater than the cross-sectional dimension of said intermediate portion of said tine disposed therein, thereby allowing said intermediate portion of said tine to rotate within said aperture around said axis of said aperture.

4. The weed removal device of claim 1, wherein the length of said intermediate portion of said tines is approximately equal, the length of said first and second outer portions of each of at least one of said tines is approximately equal, and wherein the distance of extension of said first and second outer portions of said at least one tine from said rod is approximately equal.

5. The weed removal device of claim 1, wherein the length of said intermediate portion of said times is approximately equal, the length of said first and second outer portions of each of at least one of said tines is unequal, and wherein the distance of extension of said first and second outer portions of said at least one tine from said rod is unequal.

6. The weed removal device of claim 1, wherein said apertures are disposed in longitudinally spaced relation along the portion of said rod adjacent to said second end of said rod.

7. The weed removal device of claim 6, wherein said axes of said apertures are generally perpendicular to said longitudinal axis of said rod.

8. The weed removal device of claim 7, wherein said axes of said apertures are generally perpendicular to each other.

9. The weed removal device of claim 7, wherein said axis of each of said apertures is offset from said axis of each adjacent one of said apertures by an angle of not greater than ninety degrees.

10. The weed removal device of claim 1, wherein said angle between said first and second outer portions of each of said tines and said intermediate portion of each of said tines is approximately ninety degrees, and wherein said first and second outer portions of each of said tines extend from said intermediate portion of said tine in opposite directions.

11. The weed removal device of claim 1, wherein said angle between said first and second outer portions of each of said tines and said intermediate portion of each of said tines is approximately forty-five degrees, and wherein said first and second outer portions of each of said tines extend from said intermediate portion of said tine in opposite directions.

12. The weed removal device of claim 2, wherein the length of said first and second outer portions of each tine is approximately equal, wherein each of said first and second outer portions of each of said tines has an outer end, and wherein each of said first and second outer portions of each of said tines, except for the one of said tines disposed in the one of said apertures nearest to said second end of said rod, is bent between the intersection of said outer portion and said intermediate portion and said outer end, to extend farther outwardly from said rod.

13. The weed removal device of claim 2, wherein the length of said first outer portion of each of said tines is greater than the length of said second outer portion of each of said tines, wherein said first outer portion of each of said tines has an outer end, and wherein said first outer portion of each of said tines, except for the one of said tines disposed in the one of said apertures nearest to said second end of said rod, is bent between the intersection of said first outer portion and said intermediate portion of said tine to extend farther outwardly from said rod.

14. The weed removal device of claim 1, wherein said rod is generally circular in cross-sectional configuration and wherein each of said tines is generally circular in cross-sectional configuration.

15. The weed removal device of claim 1, wherein said rod includes a soil breaking point at said second end thereof.

16. A weed removal device, comprising
an elongate rod having a first end, a second end, a lower portion adjacent to said second end, and a longitudinal axis, said rod being rotatable around said longitudinal axis, said rod being penetrated by a plurality of apertures, each having an axis, said apertures extending through said rod with said axes of said apertures generally perpendicular to said longitudinal axis of said rod and generally parallel to each other, with said apertures disposed in longitudinally spaced apart relation within said lower portion of said rod; and
a plurality of tines, equal in number to the number of said apertures, each of said tines having a first outer portion, a second outer portion, and an intermediate portion between said first and second outer portions, said first outer portion of each of said tines approximately equal in length to said second outer portion of said tine, each of said tines extending through a respective one of said apertures with said intermediate portion of said tine loosely disposed in said aperture and with said first and second outer portions of said tine being bent away from said intermediate portion of said tine at an angle of not greater than ninety degrees and extending outwardly from said rod in generally opposite directions relative to each other.

17. The weed removal device of claim 16, wherein each of said first and second outer portions of each of said tines, except for the one of said tines disposed in the one of said apertures nearest to said second end of said rod, is bent between the intersection of said outer portion and said intermediate portion and said outer end, to extend farther outwardly from said rod.

18. A weed removal device, comprising
an elongate rod having a first end, a second end, a lower portion adjacent to said second end, and a longitudinal axis, said rod being rotatable around said longitudinal axis, said rod being penetrated by a plurality of apertures, each having an axis, said apertures extending through said rod with said axes of said apertures generally perpendicular to said longitudinal axis of said rod and generally parallel to each other, with said apertures disposed in longitudinally spaced apart relation within said lower portion of said rod; and
a plurality of tines, equal in number to the number of said apertures, each of said tines having a first outer portion, a second outer portion, and an intermediate portion between said first and second outer portions, each of said tines extending through a respective one of said apertures with said intermediate portion of said tine loosely disposed in said aperture, said first outer portion of each of said tines except for the one of said tines extending through the one of said apertures nearest to said second end of said rod being of greater length than said second outer portion of said tine, said first and second outer portions of each of said tines being bent away from said intermediate portion of said tine at an angle of not greater than ninety degrees and extending outwardly from said rod in generally opposite directions relative to each other.

19. The weed removal device of claim 18, wherein said first outer portion of each of said tines has an outer end, and wherein each of said first outer portions of greater length than said second outer portion of the same one of said tines is bent between the intersection of said first outer portion and said intermediate portion of said tine to extend farther outwardly from said rod.
